(19) United States
(12) Patent Application Publication
(10) Pub. No.: US 2020/0346579 A1
(43) Pub. Date: Nov. 5, 2020

(54) SPOT BEAM FOR HARVESTING HEADER FIELD ALIGNMENT

(71) Applicant: Deere & Company, Moline, IL (US)

(72) Inventors: Nathan R. Demski, Durango, IA (US); Matthew Lommen, Bettendorf, IA (US)

(21) Appl. No.: 16/398,726

(22) Filed: Apr. 30, 2019

(51) Int. Cl. B60Q 1/32; G05D 1/02; A01D 75/00; A01B 69/04; B62D 6/00

(52) U.S. Cl. CPC B60Q 1/32; G05D 1/0212; G05D 2201/0201; A01B 69/008; B62D 6/00; A01D 75/00

(57) ABSTRACT

A harvester including a header having a first illumination device positioned on a right outermost arm of the header and a second illumination device positioned on a left outermost arm on the header. The first and second illumination devices each project a spot beam of light in a corresponding direction of travel of the harvester to illuminate a right edge travel path of the right outermost arm and to illuminate a left edge travel path of the left outermost arm. The first and second illumination devices, respectively, are configured to illuminate right and left crop dividers, respectively, mounted on the right and left outermost arms. The harvester may include an auto-steering system to rotate a steering wheel of the harvester to a designated steering angle and to rotate the first and second illumination devices to a first and second angle, respectively, that correspond to the designated steering angle.

### FIELD OF THE DISCLOSURE

The present disclosure relates to an agricultural harvester and more particularly to a lighting mechanism for identifying outer edges of a harvesting header in relation to a direction of travel of the harvester in a field.

### BACKGROUND

As farms become larger, harvesting equipment such as combines have also become bigger and wider as farm operators try to harvest these larger areas within a harvesting period. As the machines become larger the distance between the operator and the header can be 70 feet or more which increases the difficulty for the operator to visually identify an edge of the header or even a small crop divider mounted on the header. As headers for work machines increase in length to enable operators to cover more field with each pass of the work machine, it has become more difficult for an operator to visually identify the outer edges of the header. Moreover, operators often work in field conditions that are not well illuminated making it more difficult to identify the outer edges of the header. For example, farm operators typically work late into the night in reduced visibility situations due to reduced sunlight and/or dust or other pollutants in the air. Visual identification of the outer edges is important to avoid possible damage to the header.

In one crop harvesting operation such as corn harvesting with these larger machines, the tall wide-bladed stalks of corn make it difficult for the operator to visually identify a crop divider that penetrates between the rows of corn being harvested. In these operating conditions it is hard for the operator to judge the height of the crop divider points. One solution in the past has been to illuminate lower corn shoots with a light between the rows of corn. There is no forward projection of light and thus difficult for the operator to determine the location of the edge of the header for continued movement between the rows of corn.

Harvesting equipment also includes various types of lights located at different locations on the harvesting equipment. One type of light is an outline marker light that helps identify an outline of the equipment so that when the equipment is traveling on the road with other vehicles, the outline marker lights indicate the outline of the equipment for other vehicles to avoid contact with the equipment. Another type of light is a flasher or hazard light that functions similar to a car. For example, a head towed behind the harvester includes lights for towing, brake lights, and/or hazard lights. Yet another type of light is a headlight which emits a blanket of light but does visually identify an edge of the header.

### SUMMARY

In one embodiment of the present disclosure, a work machine comprising: a header having a right outermost arm opposite a left outermost arm; a first illumination device positioned on the right outermost arm, the first illumination device being configured to project a spot beam of light in a corresponding direction of travel of the work machine to illuminate a right edge travel path of the right outermost arm; and a second illumination device positioned on the left outermost arm, the second illumination device is configured to project a spot beam of light in a corresponding direction of travel of the work machine to illuminate a left edge travel path of the left outermost arm.

In one example of the work machine, the first and the second illumination devices are each configured to project one or more of a blue, red, or green colored light.

In a second example of the work machine, the right outermost arm includes a right mounting location configured to receive the first illumination device, the left outermost arm includes a left mounting location configured to receive the second illumination device. In a further embodiment, the right mounting location includes a right knee configured to receive the first illumination device, the left outermost arm includes a left knee configured to receive the second illumination device.

In a third example of the work machine, the first illumination device is configured to illuminate a right crop divider mounted on the right outermost arm, and the second illumination device is configured to illuminate a left crop divider mounted on the left outermost arm.

In a fourth example of the work machine, the work vehicle includes an auto-steering system operably connected to an electronic control unit, the auto-steering system configured to control and rotate a steering wheel of the work vehicle to a designated steering angle; the first illumination device is configured to rotate a first angle that corresponds to the designated steering angle; and the second illumination device is configured to rotate a second angle that corresponds to the designated steering angle.

In a fifth example of the work machine, the work vehicle includes a steering wheel configured to rotate to a designated steering angle; the first illumination device is configured to rotate a first angle that corresponds to the designated steering angle; and the second illumination device is configured to rotate a second angle that corresponds to the designated steering angle.

In a second embodiment of the present disclosure, a method comprising: providing a work machine having a harvesting head, the harvesting head having a right outermost arm opposite a left outermost arm, a first illumination device positioned on the right outermost arm, and a second illumination device positioned on the left outermost arm; projecting a first spot beam of light from the first illumination device to illuminate a right edge travel path of the right outermost arm; and projecting a second spot beam of light from the second illumination device to illuminate a left edge travel path of the left outermost arm.

In a first example of the second embodiment, the method further comprising: positioning the first illumination device on a right mounting location of the right outermost arm; and positioning the second illumination device on a left mounting location of the left outermost arm.

In a second example of the second embodiment, the right mounting location includes a right knee configured to receive the first illumination device, and the left mounting location includes a left knee configured to receive the second illumination device.

In a third example of the second embodiment, further comprising: illuminating a right crop divider mounted on the right outermost arm with the first illumination device; and illuminating a left crop divider mounted on the left outermost arm with the second illumination device.

In a fourth example of the second embodiment, the first and the second illumination devices emit one or more of a blue, a red, or a green colored light.

In a fifth example of the second embodiment, the method further comprising: rotating a steering wheel of the work vehicle to a designated steering angle; rotating the first illumination device a first angle that corresponds to the designated steering angle; and rotating the second illumination device a second angle that corresponds to the designated steering angle.

In a sixth example of the second embodiment, the method further comprises controlling steering of the work vehicle with an auto-steering system operably connected to an electronic control unit to a designated steering angle; rotating the first illumination device to a first angle that corresponds to the designated steering angle; and rotating the second illumination device to a second angle that corresponds to the designated steering angle.

In a third embodiment of the present disclosure, a kit for assembly with a work machine, the kit comprising: a first illumination device configured for attachment to a right outermost arm of the work machine, the first illumination device is configured to project a spot beam of light to illuminate a right edge travel path of the right outermost arm; and a second illumination device configured for attachment to a left outermost arm of the work machine, the second illumination device is configured to project a spot beam of light to illuminate a left edge travel path of the left outermost arm.

In a first example of the third embodiment, the first and the second illumination devices are further configured for operable connection to an auto-steering system of the work machine.

In a second example of the third embodiment, the first illumination device is further configured to provide a first direction indicator light, and the second illumination device is further configured to provide a second direction indicator light.

In a third example of the third embodiment, the first illumination device is configured to illuminate a right crop divider mounted on the right outermost arm, and the second illumination device is configured to illuminate a left crop divider mounted on the left outermost arm.

In a fourth example of the third embodiment, the first and the second illumination devices are each configured to project one or more of a blue, red, or green colored light.

In a fifth example of the third embodiment, the first and the second illumination devices are further configured for a rotatable attachment to the right and the left outermost arms, respectively.

This summary is provided to introduce a selection of concepts that are further described below in the illustrative embodiments. This summary is not intended to identify key or essential features of the claimed subject matter, nor is it intended to be used as an aid in limiting the scope of the claimed subject matter. Further embodiments, forms, objects, features, advantages, aspects, and benefits shall become apparent from the following description and drawings.

### BRIEF DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is a perspective view of a harvester according to one embodiment;

FIG. 2 is a side view of a harvester according to another embodiment;

FIG. 3 is a partial view of a harvester according to another embodiment;

FIG. 4 is a front view of an illumination device according to one embodiment;

FIG. 5 is a top view of the harvester of FIG. 3 with the illumination devices pointing in a forward direction relative to the forward direction of travel of the harvester;

FIG. 6 is a top view of the harvester of FIG. 3 with the illumination devices pointing a right direction relative to the forward direction of travel of the harvester; and

FIG. 7 is a top view of the harvester of FIG. 3 with the illumination devices pointing a left direction relative to the forward direction of travel of the harvester.

Corresponding reference numerals are used to indicate corresponding parts throughout the several views.

### DETAILED DESCRIPTION

For the purposes of promoting an understanding of the principles of the present disclosure, reference will now be made to the embodiments described herein and illustrated in the drawings and specific language will be used to describe the same. It will nevertheless be understood that no limitation of the scope of the present disclosure is thereby intended, such alterations and further modifications in the illustrated devices and methods, and such further applications of the principles of the present disclosure as illustrated therein being contemplated as would normally occur to one skilled in the art to which the present disclosure relates.

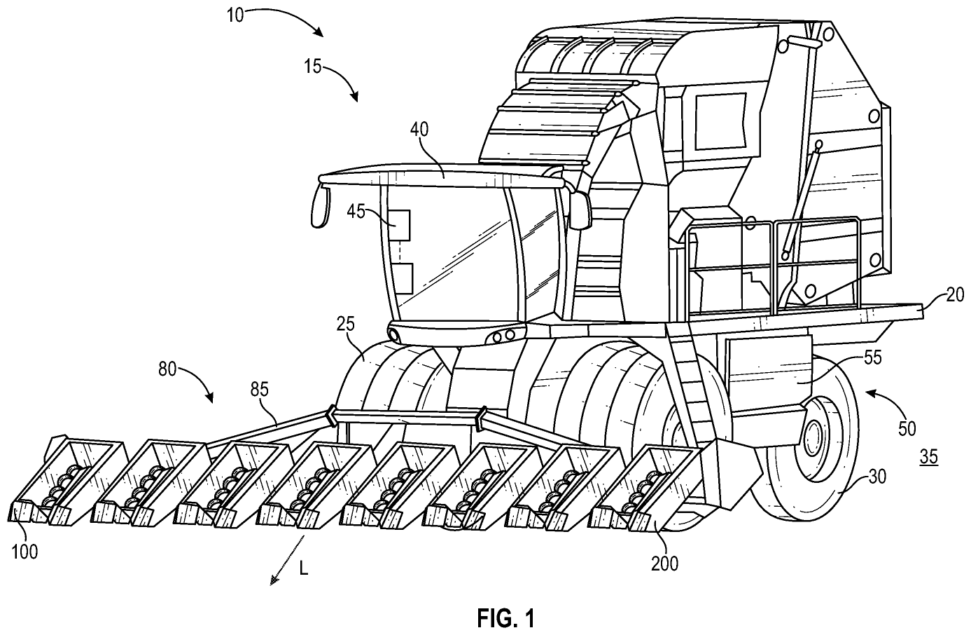

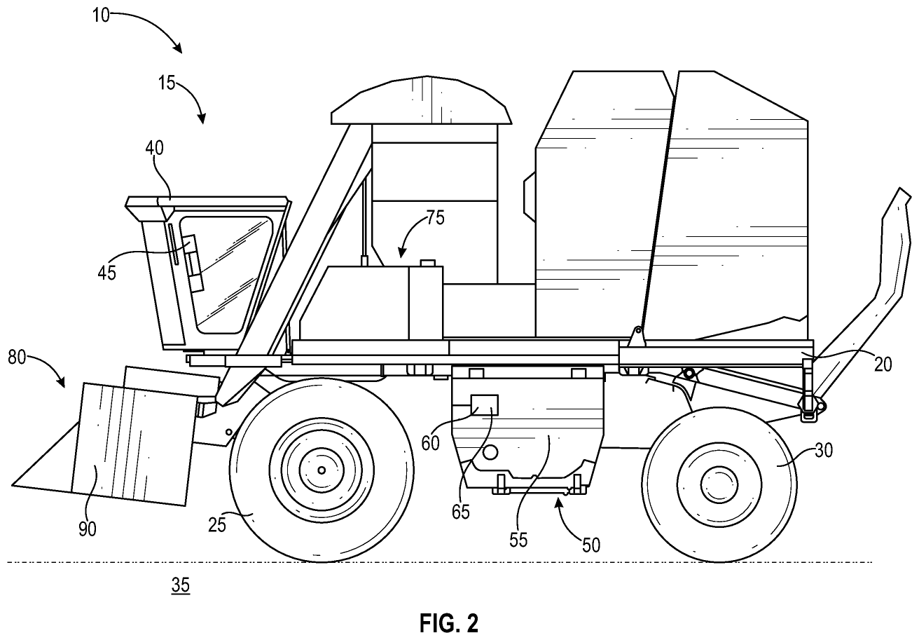

Referring to FIGS. 1 and 2 of the present disclosure, illustrate a harvester 10. The illustrated harvester 10 is a cotton harvester 15 (e.g., cotton picker, cotton stripper). However, other types of harvesters 10 and work machines generally are contemplated by this disclosure (e.g., combines, tractors, windrowers, motor vehicles).

The harvester 10 includes a chassis 20. The illustrated chassis 20 is supported by front wheels 25 and rear wheels 30 although other types of support are contemplated (e.g., tracks). The harvester 10 is adapted for movement through a field 35 to harvest crops (e.g., cotton, corn, stover, hay, and alfalfa among others). An operator station 40 is supported by the chassis 20. An operator interface 45 is positioned in the operator station 40.

Referring to FIG. 2, a power module 50 may be supported below the chassis 20. The power module may be an engine 55 that drives a hydraulic motor 60 or a mechanical drive 65. An operator may set a minimum power for the power module 50 from the operator interface 45. The operator may also set a minimum engine speed from the operator interface 45. Water, lubricant, and fuel tanks, indicated generally at 75, may be supported on the chassis 20.

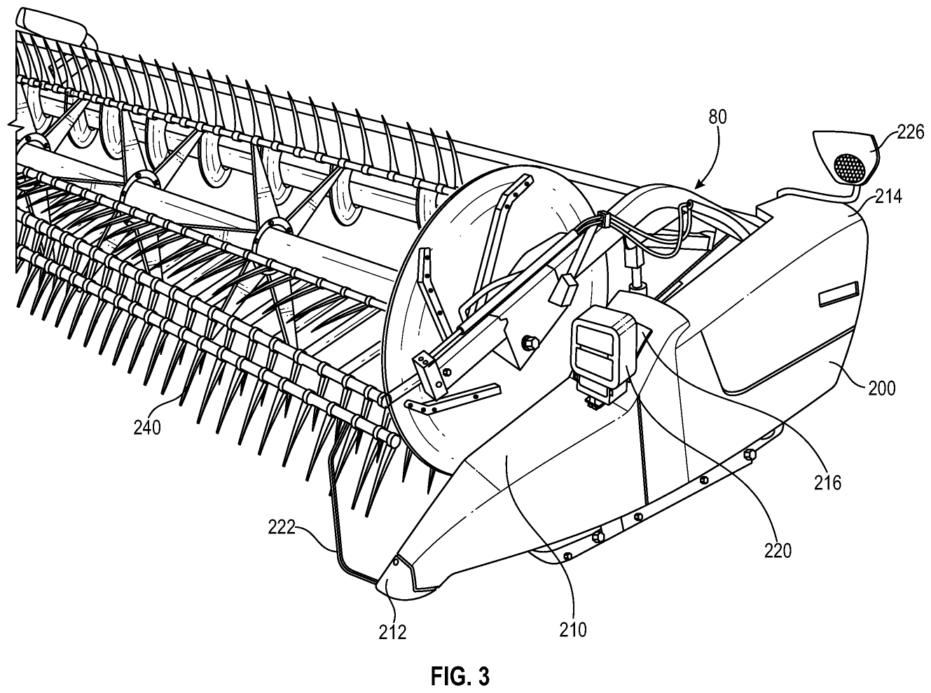

A header or harvesting structure 80 is coupleable to the chassis 20. The illustrated harvesting structure 80 is configured to remove cotton from the field 35. The header or harvesting structure 80 may be a cotton stripper header 85 (FIG. 1), one or more cotton picking units 90 (FIG. 2), or another harvesting structure 80 (e.g., corn head, see FIG. 3). Alternatively, the harvesting structure 80 may be configured to remove corn, wheat, or other crop.

As illustrated in FIGS. 1 and 3, the header or harvesting structure 80 includes a right outermost arm 100 opposite a left outermost arm 200. The header or harvesting structure 80 may include additional arms arranged between the right and left outermost arms 100 and 200. The forward operating direction of the harvester 10 determines the “left” side of the harvester 10 and left outermost arm 200 and also similarly determines the “right” side of the harvester 10 and the right outermost arm 100. The right outermost arm 100 includes similar features as the left outermost arm 200, therefore for the sake of brevity similar features will not be disclosed. Also illustrated in FIG. 3, a cutterbar 240 is disposed at a forward end of the header 80 and is used in order to harvest and cut crop such as wheat or corn.

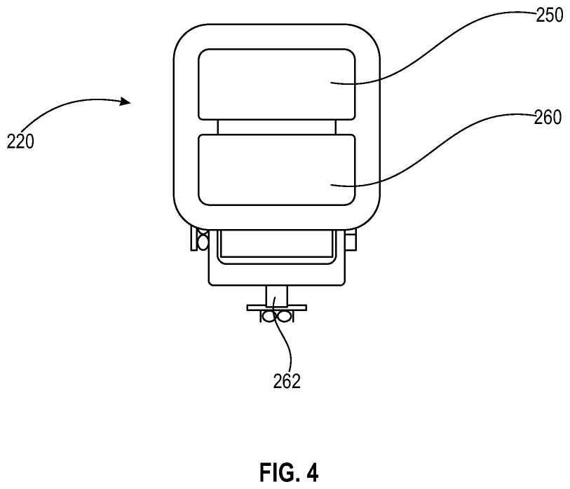

As illustrated in FIG. 3, the left outermost arm 200 of another type of header or harvesting structure 80 includes a left mounting location 210 that spans between a forward end 212 and a rearward end 214 of the left outermost arm 200 wherein the left mounting location 210 is configured to receive a first illumination device 220 illustrated in FIG. 4. It is contemplated that the illuminate device 220 can be positioned on other types of exterior arms of the header or harvesting structure 80 illustrated in FIGS. 1, 2, and 3, as well as other types of work machines. In one form, the left mounting location 210 includes a left knee 216 configured to receive the first illumination device 220. The left mounting location 210 is further configured to receive a connector 262 of the first illumination device 200 to mount the first illumination device 200 on the left outermost arm 200. The left outermost arm 200 includes a left crop divider 222 wherein the first illumination device 220 is configured to illuminate the left crop divider 222. Optionally, the left outermost arm 200 includes a left direction indicator light 226.

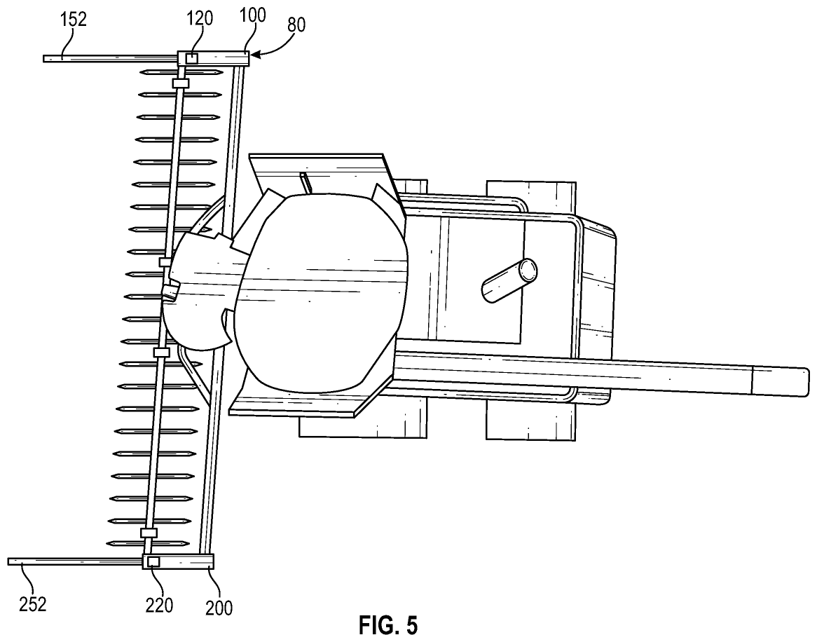

One form of the first illumination device 220 is illustrated in FIG. 4 however other forms may be used with the present application. A second illumination device 120 is similar to the first illumination device 220 therefore will not be described for the sake of brevity. The first illumination device 220 includes a light emitting diode (“LED”) light 250 configured to project a spot or pencil beam light 252 to illuminate a left edge travel path of the left outermost arm 200. As can be appreciated, the LED light 250 does not project a wide column of light but instead a narrow or spot beam pencil light 252 as illustrated in FIGS. 5, 6, and 7. The first illumination device 220 projects the spot beam of light 252 in a corresponding direction of travel of the header 80 to illuminate the left edge travel path of the left outermost arm 200 to aid the operator in identifying the location of the left edge of the harvesting structure 80. Similarly, the right illumination device 120 projects a spot beam of light 152 in a corresponding direction of travel of the header 80 to illuminate the right edge travel path of the right outermost arm 100 to aid the operator in identifying the location of the right edge of the harvesting structure 80.

The first illumination device 220 also includes a connector 262 to attach the first illumination device 220 with the left outermost arm 200. In one form, the first illumination device 220 and the second illumination device 120 are included in a light kit that is assembled with a harvester. For example, a harvester or other work machine can be fitted with a light kit that includes the first illumination device 220, the second illumination device 120, and any connectors 262 used to attach the first and second illumination devices 220 and 120 to the outer arms or members of work machine.

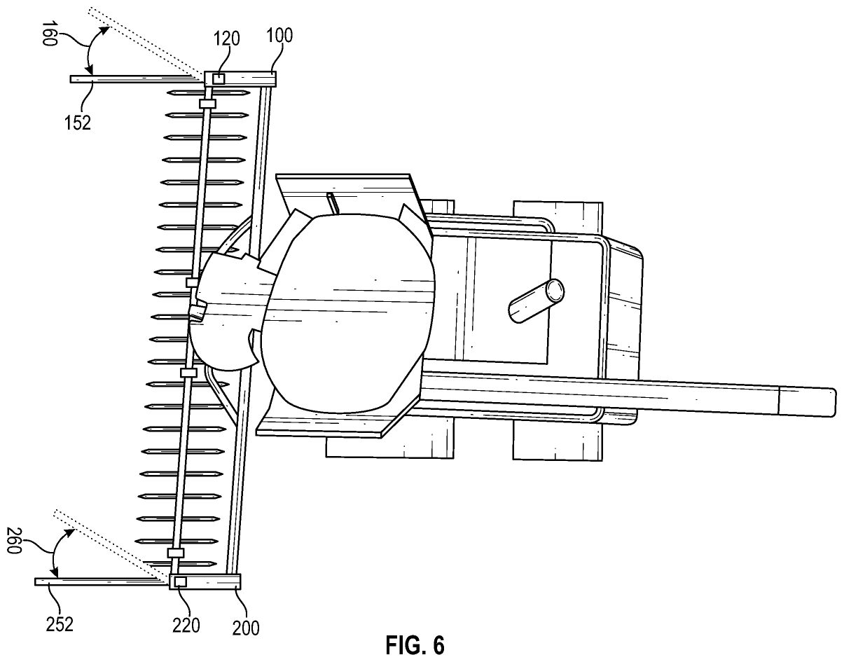

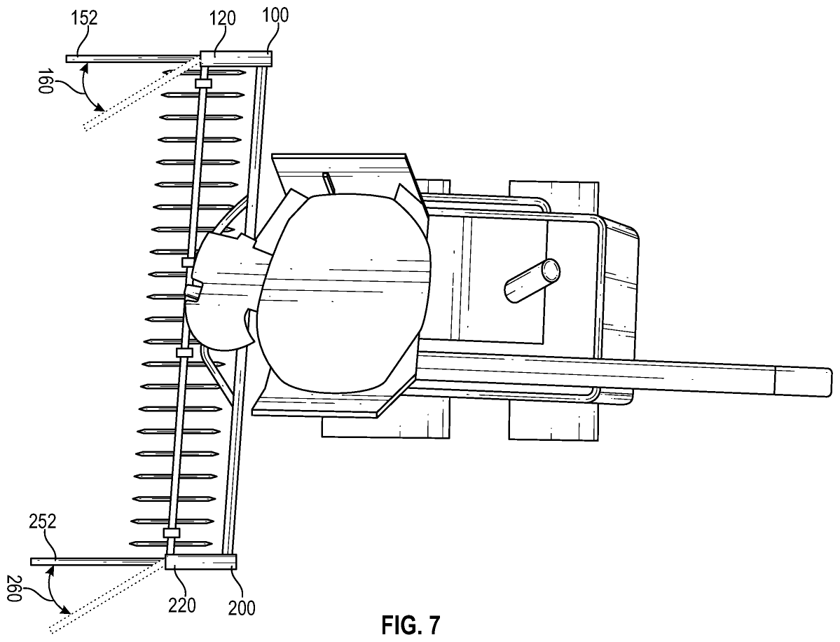

The connector 262 can be any type of connecting means and can be configured to enable the first illumination device 220 to swivel or rotate about the left outermost arm 200. Alternatively, the connector 262 can be any type of connecting means to fixedly attach the first illumination device 220 to the left outermost arm 200. In this form, the first illumination device 220 can be configured to enable the first illumination device 220 to swivel or rotate about the left outermost arm 200. For example, as the operator initiates or turns a steering wheel of the harvester 10, it would be beneficial to swivel the projection of light 252 and the projection of light 152, as illustrated in FIGS. 6 and 7, so that as the operator turns the harvester 10 the spot beam pencil light 252 and 152 also pivot or swivel in the same direction. As one can appreciate in a turning situation, the spot beam pencil light 252 and 152 can indicate the general direction that the left and right outermost arms 200 and 100 will travel which corresponds to a designated steering angle of the harvester 10 and a future path of the harvester 10. The first illumination device 220 is configured to rotate a first angle 260 that corresponds to the designated steering angle. The second illumination device 120 is configured to rotate a second angle 160 that corresponds to the designated steering angle. As can be appreciated, the spot beam of light 252 and 152 are straight while the left and right outermost arms 200 and 100 will travel in an arc when the operator turns the harvester 10. As described further below, the first and second illumination devices 220 and 120 can be used with an autodrive steering system of the harvester 10.

In one form, the LED light 250 is a blue spot beam of light. In other forms, the LED light 250 can be any color such as red, green, or yellow light that enables an operator to change the color hue of the spot beam of light in the field to any color depending on desired operating conditions. Changing the color of the light that corresponds to operating or field conditions may be beneficial for example when the amount of dust, air pollutants, work environment, or even the operator changes. Optionally, the first illumination device 220 can include a second LED light 260. Alternatively, the first illumination device 220 can include a direction indicator light instead of or additional to the left direction indicator light 226 that is mounted on the left outermost arm 200.

The operation of the harvester 10 is controlled from the operator station 40. The operator station 40 may include any number of controls (not shown) for controlling the operation of the harvester 10. A controller (not shown) may be electrically coupled to the plurality of controls, and the controller may control the functionality of the harvester 10 and including the first illumination device 220 and the second illumination device 120 through the operator interface 45. The operator interface 45 may include a display (not shown) for displaying various characteristics of the harvester 10 such as, but not limited to, speed, fluid temperatures, fluid pressures, direction of travel, etc. The display may be a touchscreen display that allows the operator to control certain functions of the machine and the first illumination device 220 and the second illumination device 120 by touching a button on the display. Other uses of the operator interface 45 may be available and this disclosure is not intended to be limited in any way with respect to the functionality of the operator controls or user interface.

The operator interface 45 may also include controls for controlling movement of the harvester 10. Additionally the operator interface 45 may include an autodrive steering system that is operably connected to the controller or electronic control unit wherein the autodrive steering system is configured to control and rotate a steering wheel of the harvester 10 to a designated steering angle. For example, when the harvester 10 is operating in the autodrive steering mode of operation, when the steering wheel turns to the right at a designated steering angle R, then the first and second illumination devices 220 and 120 will swivel or turn the corresponding direction by the first angle 260 and the second angle 160, respectively, that correspond to the designated steering angle R. Similarly, when the harvester 10 is operating in the autodrive steering mode of operation, when the steering wheel turns to the left at a designated steering angle L, then the first and second illumination devices 220 and 120 will swivel or turn the corresponding direction by the first angle 260 and the second angle 160, respectively, that correspond to the designated steering angle L. In either direction, the first and second illumination devices 220 and 120 illuminate a projected path of the header 80. Alternatively, the operator interface 45 does not include an autodrive steering mode of operation and the operator manually rotates a steering wheel of the work vehicle to a designated steering angle R or L, and the first illumination device 220 is rotated to the first angle 260 that corresponds to the designated steering angle R or L and the second illumination device 120 is rotated to the second angle 160 that corresponds to the designated steering angle R or L.

While this disclosure has been described with respect to at least one embodiment, the present disclosure can be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains.

What is claimed is:

1. A work machine comprising:
a header having a right outermost arm opposite a left outermost arm;
a first illumination device positioned on the right outermost arm, the first illumination device being configured to project a spot beam of light in a corresponding direction of travel of the work machine to illuminate a right edge travel path of the right outermost arm; and
a second illumination device positioned on the left outermost arm, the second illumination device is configured to project a spot beam of light in a corresponding direction of travel of the work machine to illuminate a left edge travel path of the left outermost arm.

2. The work machine of claim 1, wherein the first and the second illumination devices are each configured to project one or more of a blue, red, or green colored light.

3. The work machine of claim 1, wherein the right outermost arm includes a right mounting location configured to receive the first illumination device, the left outermost arm includes a left mounting location configured to receive the second illumination device.

4. The work machine of claim 3, wherein the right mounting location includes a right knee configured to receive the first illumination device, the left outermost arm includes a left knee configured to receive the second illumination device.

5. The work machine of claim 1, wherein the first illumination device is configured to illuminate a right crop divider mounted on the right outermost arm, and the second illumination device is configured to illuminate a left crop divider mounted on the left outermost arm.

6. The work machine of claim 1, wherein the work vehicle includes an auto-steering system operably connected to an electronic control unit, the auto-steering system configured to control and rotate a steering wheel of the work vehicle to a designated steering angle;
the first illumination device is configured to rotate a first angle that corresponds to the designated steering angle; and
the second illumination device is configured to rotate a second angle that corresponds to the designated steering angle.

7. The work machine of claim 1, wherein the work vehicle includes a steering wheel configured to rotate to a designated steering angle;
the first illumination device is configured to rotate a first angle that corresponds to the designated steering angle; and
the second illumination device is configured to rotate a second angle that corresponds to the designated steering angle.

8. A method comprising:
providing a work machine having a harvesting head, the harvesting head having a right outermost arm opposite a left outermost arm, a first illumination device positioned on the right outermost arm, and a second illumination device positioned on the left outermost arm;
projecting a first spot beam of light from the first illumination device to illuminate a right edge travel path of the right outermost arm; and
projecting a second spot beam of light from the second illumination device to illuminate a left edge travel path of the left outermost arm.

9. The method of claim 8, further comprising:
positioning the first illumination device on a right mounting location of the right outermost arm; and
positioning the second illumination device on a left mounting location of the left outermost arm.

10. The method of claim 9, wherein the right mounting location includes a right knee configured to receive the first illumination device, and the left mounting location includes a left knee configured to receive the second illumination device.

11. The method of claim 8, further comprising:
illuminating a right crop divider mounted on the right outermost arm with the first illumination device; and
illuminating a left crop divider mounted on the left outermost arm with the second illumination device.

12. The method of claim 8, wherein the first and the second illumination devices emit one or more of a blue, a red, or a green colored light.

13. The method of claim 8, further comprising:
rotating a steering wheel of the work vehicle to a designated steering angle;
rotating the first illumination device a first angle that corresponds to the designated steering angle; and
rotating the second illumination device a second angle that corresponds to the designated steering angle.

14. The method of claim 8, further comprising:
controlling steering of the work vehicle with an auto-steering system operably connected to an electronic control unit to a designated steering angle;
rotating the first illumination device to a first angle that corresponds to the designated steering angle; and
rotating the second illumination device to a second angle that corresponds to the designated steering angle.

15. A kit for assembly with a work machine, the kit comprising:
a first illumination device configured for attachment to a right outermost arm of the work machine, the first illumination device is configured to project a spot beam of light to illuminate a right edge travel path of the right outermost arm; and
a second illumination device configured for attachment to a left outermost arm of the work machine, the second illumination device is configured to project a spot beam of light to illuminate a left edge travel path of the left outermost arm.

16. The kit of claim 15, wherein the first and the second illumination devices are further configured for operable connection to an auto-steering system of the work machine.

17. The kit of claim 15, wherein the first illumination device is further configured to provide a first direction indicator light, and the second illumination device is further configured to provide a second direction indicator light.

18. The kit of claim 15, wherein the first illumination device is configured to illuminate a right crop divider mounted on the right outermost arm, and the second illumination device is configured to illuminate a left crop divider mounted on the left outermost arm.

19. The kit of claim 15, wherein the first and the second illumination devices are each configured to project one or more of a blue, red, or green colored light.

20. The kit of claim 15, wherein the first and the second illumination devices are further configured for a rotatable attachment to the right and the left outermost arms, respectively.
